(19) United States
(12) Patent Application Publication
(10) Pub. No.: US 2011/0000742 A1
(43) Pub. Date: Jan. 6, 2011

(54) Device for Evacuating People from a Building

(75) Inventors: Werner Hafliger, Mettmenstetten (CH); Anton Schwyter, Buonas (CH)

Correspondence Address: BRIAN ROFFE, ESQ, 8170 McCormick Boulevard, Suite 223, Skokie, IL, 60076-2914, US

(73) Assignee: AH INVENTION AG, BUONAS (CH)

(21) Appl. No.: 12/810,589

(22) PCT Filed: Dec. 23, 2008
(86) PCT No.: PCT/EP08/11077

§ 371 Date: Sep. 13, 2010

(30) Foreign Application Priority Data
Dec. 27, 2007 (CH) 02021/07
Apr. 2, 2008 (CH) 00508/08

(51) Int. Cl. A62B 1/16; A62B 35/00; A62B 1/06

(52) U.S. Cl. 182/42

(57) ABSTRACT

A device (70) for evacuating people from a building is provided with a rescue member via which people can be brought from an upper storey of the building (2) to ground level (28). The rescue member has at least one rope (20), belt or similar, which is let down from the upper storey of the building (2) along the building wall to ground level (28). At specified intervals on this rope (20), support members (31) are arranged with which, in each of the storeys, a carrying element (32) can be connected, on which at least one person is held. The carrying elements (32) are automatically detachable in an area close to ground level (28). This device (7′) enables people to be evacuated safely and easily.

The invention concerns a device for evacuating people from a building according to the preamble of claim 1.

A device of this type is known for example from EP 1 494 758. This comprises a tube which is folded together in the non-functional position and unfolds into a functional position, which in the functional position forms an essentially vertical rescue channel leading from an upper storey of the building to ground level. As braking means for the safe conveyance of people through the rescue channel to ground level, in the interior of the tube there are annular cushions, made from an elastic, flexible material, which are inflatable with air or a medium, which when the tube unfolds are automatically filled with a medium.

The present invention is based on the problem of creating a device of the aforementioned type which optimises the evacuation procedure and which is nevertheless simple and economical in embodiment.

This problem is solved according to the invention by a device with the features of claim 1.

Other preferred embodiments of the device according to the invention form the subject matter of the dependent claims.

The device according to the invention enables safe, easy evacuation of people, regardless of whether they are adults or children, and regardless of the physical size of the person to be rescued. Also, it can not only be brought quickly into the functional position, but it can also be quickly returned to the non-functional position. Also, due to its simple structure, devices can be provided on several floors so that people can leave the building and can be brought to safety even more quickly. Platforms could also be provided on several floors, however, from which people could connect to the rope running past these.

The invention is next explained in more detail with the aid of the drawing, which shows:

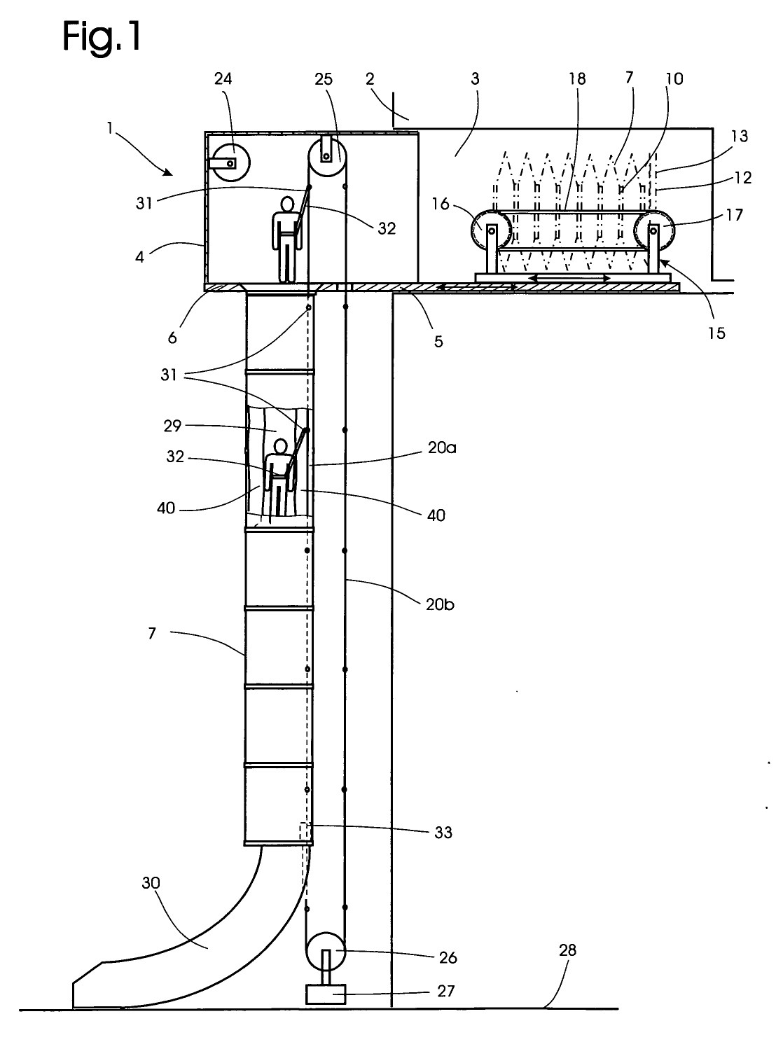

FIG. 1 shows an embodiment of the device of the invention for evacuating persons from a building in the usage position, partially in cross-section;

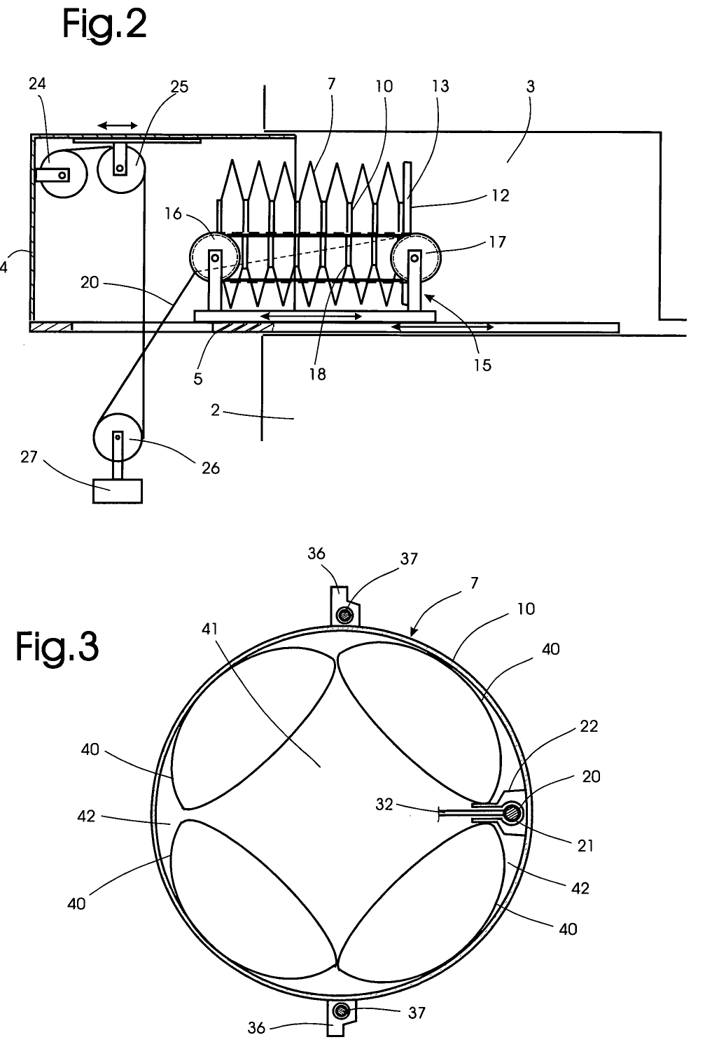

FIG. 2 shows a part of the device of FIG. 1 prior to unfolding a hose;

FIG. 3 shows a rescue channel in cross-section;

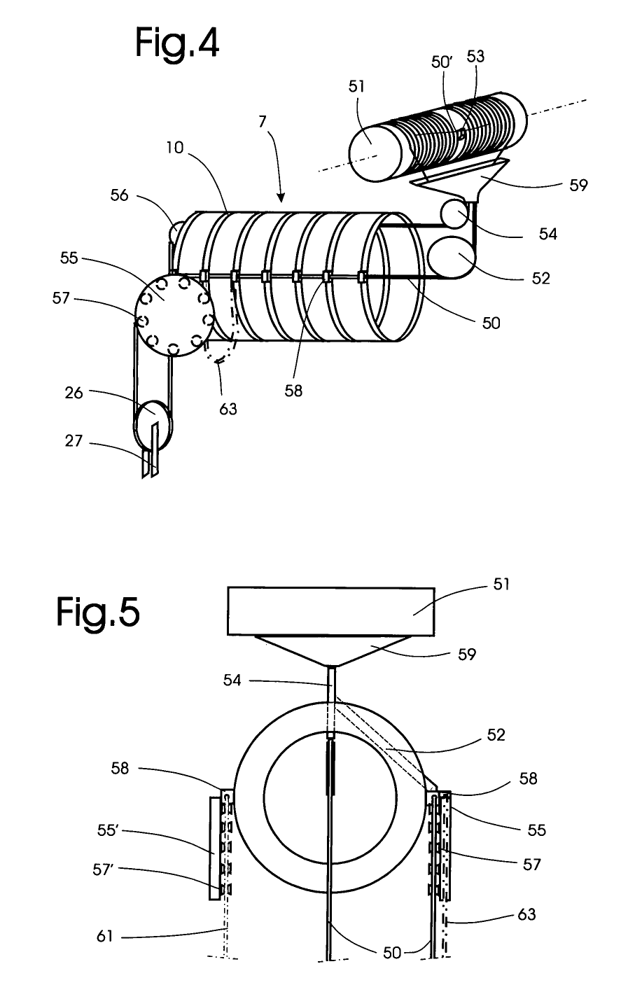

FIG. 4 shows a perspective view of a variant of a device of the invention for evacuating persons in principle in the starting position;

FIG. 5 shows a schematic front view of a part of the device of FIG. 4; and

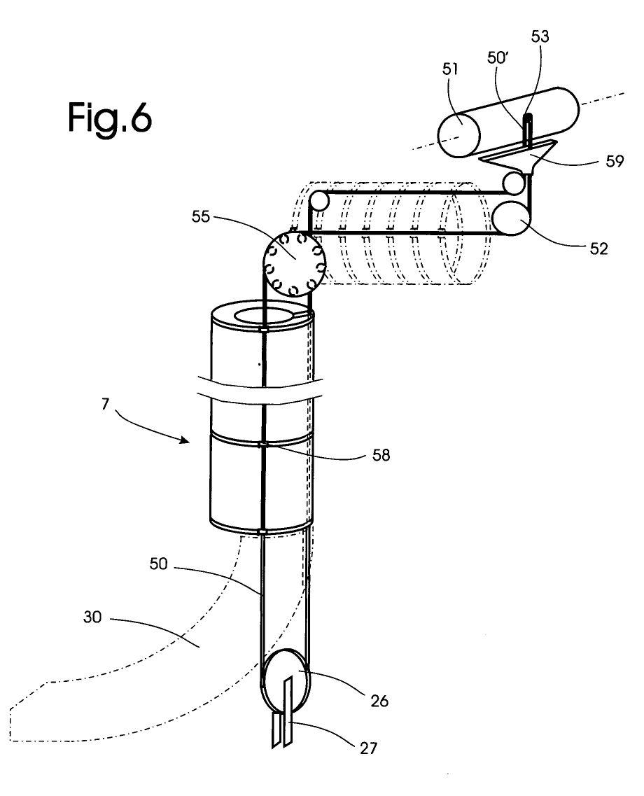

FIG. 6 shows a perspective view of the device of FIG. 4 in the usage position with extended hose,

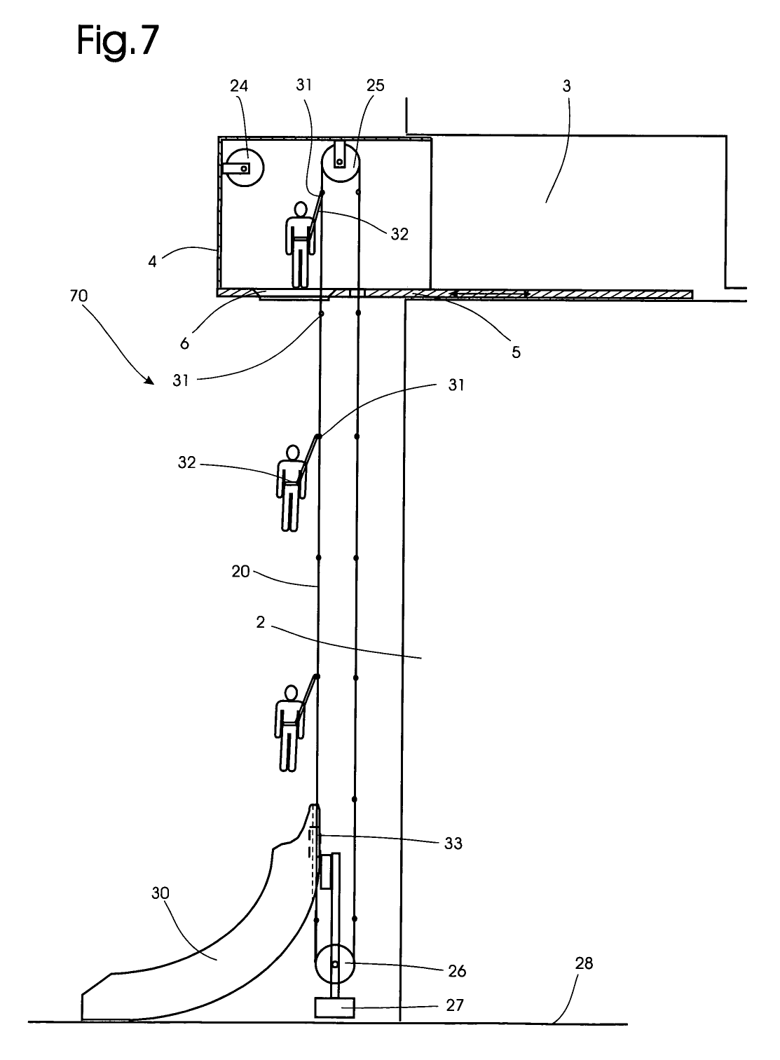

FIG. 7 shows a device of the invention in a usage position.

FIG. 1 shows a device 1 for evacuating persons from a building 2. The device 1 is stored in a room 3 on one of the upper floors of the building 2 in the non-usage position. For this it is arranged in a container that can be partially extended towards the outside from the room 3, e.g. from the building 2, the same comprising a plateau 5 with a floor opening 6 (see also FIG. 2). When the device 1 is not in use the container 4 is not visible from the outside of the building. It is possible to envisage a number of such devices per floor and several devices over several floors of the building.

The device 1 comprises a foldable hose 7 of a concertina type, equipped across its entire length with a number of transverse rings 10 arranged at a distance from each other. When the hose is folded the transverse rings 10 are pressed closely together as is shown in FIG. 2, and also in FIG. 1 by means of the broken lines.

The hose 7 is equipped with an entry part 13 comprising an entry opening 12 at one end and can be vertically inserted into the floor opening 6 from the horizontal non-usage position with the end facing away from the entry part 13 by means of a transport device 15 comprising two wheels 16, 17 and a transport chain 18 co-operating with the transverse rings 10, through which—weighed down by its own weight—the same falls and unfolds itself automatically. When this happens the transverse rings 10 slide along a rope 20 projecting through openings 21 and guide elements 22 on the inside of each transverse ring 10 (see FIG. 3).

According to FIG. 2 the rope 20, the main function of which is described in more detail below, is held with one end at the entry opening 12, and with the other end wound onto a coil 24 located within the container 4, whereby the same is routed around an upper cylinder 25 also located within the container 4 as well as a lower cylinder 26 equipped with a weight 27. In the non-usage position of the device 1, e.g. when the container 4 is not extended (not shown in the drawing) the lower cylinder 26 is located within the container 4 near the transport device 15 inside the room 3. The transport device 15 is adjustably located on the plateau 5. FIG. 2 shows a position prior to unfolding the hose, in which the transport device 15 is driven to the floor opening 6 and the lower cylinder 26 that is preferably equipped with the weight 27 is inserted into the floor opening 6. The cylinder 26 with the weight 27 is moved in a downward direction and the rope 20 is unwound from the coil 24 until the cylinder 26 is near the floor. The hose 7 which has been unfolded into its usage position shown in FIG. 1 in the meantime, and which is held at its upper end by means of the entry part 13 supported on the plateau 5, whereby the entry opening 12 lies coaxially in relation to the floor opening 6, forms an escape channel 29 extending from the upper floor to the floor 28. The lower end of the hose 7 is preferably connected with a substantially arc-shaped extension part 30 enabling a fast exit.

Once the hose has been unfolded the end of the rope 20 held by the entry part 13, e.g. the entry opening 12 is connected with the other end that has now been removed from the coil 24, so that an endless rope 20 routed around the cylinders 25, 26 is formed, one part 20a of which projects through the hose interior from the guide elements 22 already mentioned, and the other part 20b of which extends on the outside of the hose 7. The transport device 15 is then removed from the floor opening 6 on the plateau 5 back into the interior of the building.

The rope 20 serves for securing the persons to be evacuated from the upper floors of the building to the floor 28. For this purpose carrying means 31 are affixed to the rope 20 at regular intervals (for example in the form of so-called Talurit clamps), with which a carrying element 32 supporting the relevant person (for example a belt or similar) can be connected. The relevant person can connect the carrying element 32 with the carrying means 31 himself or with the assistance of the supervisor (for example hook the same up or attach a clasp). The rope 20 is then driven by means of a motor with braking effect, or by the weight of the persons—with the assistance of breaking means—in such a way that the part 20a of the rope 20 is moved in a downward direction through the hose interior. If the rope 20 is driven by means of the weight of the persons the braking means will preferably be allocated to at least one of the cylinders 25, 26.

In the lower area of the hose 7 prior to the transition from the hose 7 to the extension part 30 a mechanism 33 for the automatic disconnection of the carrying elements 32 from the carrying means 31 attached to the rope 20 is envisaged.

The lower cylinder 26 is held in the floor area by its own weight, and possibly by the additional weight 27, or it can also be fitted to the floor 28, whereby the position of the hose 7 in relation to the building wall is determined by the rope 20 and stability is guaranteed, for example for windy conditions. The rope 20 therefore has the function of a tensioning rope such as for example the one known from WO 03/086540, whereby however nothing speaks against the use of an additional tensioning rope (in addition to rope 20).

The device 1 of the invention preferably envisages protective cushions 40 inside the hose 7, the same being automatically inflated by a medium when the hose is unfolded. Several groups of at least two, possibly four protective cushions 40 (see FIG. 3) are arranged across the length of the escape channel 29 at distances from each other and preferably affixed to the transverse rings 10.

According to FIG. 3 the protective cushions 40 of the relevant group together enclose a through opening 41 for the person to be rescued at least in part in the inflated condition. Between the protective cushions 40 and the hose 7 spaces 42 are located. These permit an elastic deformation of the protective cushions 40 to suit the dimension of the through passage 41 that changes according to the circumference of the person to be rescued. It is clear from FIG. 3 that the rope 20, e.g. the section 20a of the same running through the hose interior extends through one of the spaces 42. The protective cushions 40 comprise a longitudinal cross-section extending in the direction of transport in their inflated condition (see FIG. 1). The rope 20 is practically covered along the entire length of the escape channel 29 by the protective cushions 40. The carrying elements 32 connecting the persons to be rescued with the rope 20 via the carrying means 31 are each routed between two adjacent protective cushions 40 of a protective cushion group and through the guide elements 22 attached to the transverse rings 10. It is of advantage if the uppermost group of protective cushions comprises more than two protective cushions 40 and the protective cushions enclose the entire through opening 41, which can reduce the fear of a forcibly evacuated person prior to entering the escape channel 29. In addition further guide elements 36 are indicated on the outside of the transverse rings 10, in which stabilising ropes 37 are held, which are affixed to the upper, e.g. lower end of the hose 7, and by means of which the hose 7 is additionally secured.

The hose 7 preferably consists of a flat non-flammable and heat insulating material, so that no risk to the person evacuated by means of the hose exists even in the case of a fire. Possible is also the use of a transparent material for improved monitoring of the evacuation process, or even the provision of windows in the hose. Unlike with a mesh-like material like the one used with known devices of this type the falling person being forcibly evaluated cannot get caught inside the escape channel 29 or hold on to the same in fear, and therefore cannot slow down the evacuation process.

It would also be perfectly possible to drive the rope 20 in the opposite direction and/or to transport firemen, for example, through the hose 7 in its usage position to an upper floor. It is also possible of course to use an additional hose for this transporting of rescue personnel in the opposite direction.

FIG. 4 to FIG. 6 show a variant of a device of the invention, which in principle resembles the device shown in FIG. 1, but comprises an endless rope 50 in the starting position of the hose also.

In this starting position according to FIG. 4 the hose 7 is once more shown in a horizontal position inside the container not shown in detail. This endless rope 50 is wound onto a coil spool 51 in such a way that the rope 50 is routed around a hook-shaped part 53 in the middle of the coil spool 51 in the form of a loop 50′, and is wound up starting from this part 53 to the left, e.g. the right and routed downwards on the outside and routed around a diverting cylinder 54 on the one hand, and around a diverting cylinder 52 on the other. For this purpose a transition rope guide 59 is located below the coil spool 51, with which the rope 50 is guided to the diverting cylinders 54, 55. At the diverting cylinder 54 is the rope 50 is routed through the hose 7 to a further diverting cylinder 56, and from this to the cylinder 26 with the weight 27 forming the lower end, and then back in an upward direction around a disc 55 rotatably located near the hose and on the outside of the hose 7 to the diverting cylinder 55, and from this to the coil spool 51.

In addition a rope 63 holding the relevant interim rings 10 at the teeth 58 together is illustrated by means of the broken line. In the position of the folded hose that is shown here this rope 63 forms a loop. In this illustration only one rope 63 is shown, although pairs of ropes 63 of this type are of course located between all rings 10. A relevant rope 63 of this type is extended when the hose 7 is extended and ensures that the weight forces created are not absorbed by the hose itself, but by the ropes 63.

FIG. 5 illustrates the discs 55, 55′ positioned either side of the hose 7, which comprise rotatably positioned cylinders 57, 57′ distributed around their circumference. The cylinders 57 guide the rope 50 on the one hand, and move the same on the other much like the cylinder 57′, when the discs 55, 55′ are rotated, when the hose 7 is returned to its usage position in that teeth 58 are envisaged at the side of the hose, through which the rope 50 is guided. These teeth 58 are positioned between the cylinder 57 and are carried along by the same. On the other side of the hose 7 near the disc 57′ a holding rope 61 indicated only roughly in the drawing is provided, which is located between the teeth 58 and ensures that the hose is held together in an extended position like the one shown in FIG. 6. In addition these ropes 63 each run around the disc 55 and are therefore also guided.

In FIG. 6 the hose 7 is illustrated in the usage position together with the extension part 30, whereby the rope 50 is shown in the position in which it is still held by the hook-shaped part 53. As soon as the coil spool 51 continues to turn the rope is released by the same and is then guided only around the diverting cylinder 55. The diverting cylinder 55 is then preferably brought into an analogue position much like the cylinder 25 shown in FIG. 1.

The device of the invention enables a safe problem-free evacuation of a person irrespective of whether the same is an adult or a child, and irrespective of the body circumference of the person to be rescued.

FIG. 7 shows another variant of a device 70 for the evacuation of people from a building 2, where the references are partly used the same like according to the device 1 pursuant to FIG. 1 to FIG. 3, where it is based on the same.

The device 70 is housed, in a non-functional position, in an enclosure 3 located in an upper storey of the building 2. It is thereby disposed in a container 4 which can be partially extended outwards from the enclosure 3 or from the building 2, which includes a plateau 5 with a bottom opening 6. The container 4 is not visible from outside when the device 1 is not in use. Several such devices could be provided per floor, and devices in several floors.

An endless rope 20 guided about rollers 25, 26 is used as a rescue member which is intended to bring the people being evacuated safely to ground level 28. This could also be a belt; for the sake of simplicity hereinafter, only the term “rope” will be used. Such a belt could be equipped with ropes or other reinforcement means contained therein. In principle, too, at least one chain or similar could also be used instead of a rope.

In the non-functional position of the device 70, i.e. with the container 4 retracted, the two rollers 25, 26 are inside the container 4 and the rope 20 is wound onto a spool 24. When in use, said roller 26, preferably fitted with an additional weight 27 and with the rope 20 wrapped around it, is inserted into the bottom opening 6 of the extended container 4 and moved downwards, until it reaches to near the ground, the rope 20 being unwound from the spool 24. The two ends of the rope 20 unwound from the spool 24 and guided around the rollers 25, 26 can only then be connected to the endless rope, or else an endless rope 20 can be wound onto the spool winch 24 and unwound from this. The lower roller 26 is held in the ground area by its own weight and if need be by the additional weight 27, or it can also be fastened at ground level 28. In principle, however, there may also be no roller underneath.

Support members 31 can be attached to the rope 20 at regular intervals (for example in the style of so-called Talurit rope clamps), with which a carrying element 32 carrying the respective person can be connected. The respective person can connect the carrying element 32 himself or with the aid of a supervisor to the support member 31 (e.g. hang up or latch on). The carrying element 32 can, for example, be a sling hanger or a bag at least partially encasing the person. The carrying element 32 can however also be designed as a container which can be entered, e.g. a basket.

The rope 20 is driven by a motor with braking action or by the persons' own weight—under the effect of braking means, so that the people held by the carrying elements 32 and connected with the support members 31 are moved downwards. If the rope 20 is driven by the person's own weight, the braking means are preferably assigned to at least one of the rollers 25, 26.

At ground level, a mechanism 33 for automatic detachment of the carrying elements 32 from the support members 31 attached to the rope 20 is provided, which is preferably assigned to the axis of the lower roller 26. Advantageously, an essentially curved exit part 30 can be placed underneath this mechanism 33, to facilitate a safe dismount and a rapid exit from the device 70 for the people provided with the carrying element 32 or held in the carrying element 32.

It would certainly be possible to transport e.g. rescue personnel to an upper storey using the device according to the invention.

A further, especially advantageous option consists in using, instead of a single rope or belt 10, two ropes or belts 10 running parallel to each other and provided with support members 31, and guiding these, for example, around the rollers 11, 12. The respective carrying element 32 holding one person would then be connected with a support member 31 of each of the two ropes or belts 10, which would contribute to the stabilisation of the position of the person to be transported.

It would, however, also be possible to provide corresponding platforms on various floors, which would serve to connect people on these platforms with the rope running past them in the way explained above and thus make it possible for people to be evacuated from more than one floor.

Obviously several people could also be fastened simultaneously to one carrying element, for example there could be a hoop with several seats or a crossbar with several sling hangers fastened thereon or similar.

Theoretically in the above mentioned devices the rope could also be positioned in a stationary way. This would have the advantage that the rope would not have to be returned to the top via diverting cylinders. The carrying means on which the persons are held would then each be held and guided by a sledge that could be driven along the stationary rope. The sledge would preferably be equipped with rollers enclosing the rope, which would roll down the rope under a braking effect. A relevant sledge would then run along the rope under the influence of a certain braking effect.

1. Device for evacuating people from a building (2), with a rescue member via which people can be brought from an upper floor of the building (2) to ground level (28), characterised in that
the rescue member has at least one rope (20), belt or similar, let down from the upper storey of the building (2) along the building wall to ground level (28), having at specific intervals support members (31) arranged on said rope or belt; in each storey a carrying element (32) can be connected with said support members, on which carrying element at least one person is held, whereby the carrying elements (32) are automatically detachable from the support members (31) attached to the rope (20) or belt in an area near to ground level (28).

2. Device according to claim 1, characterised in that the respective person-holding carrying element (32) can be hung or hitched or clamped onto the support member (31).

3. Device according to claim 1, characterised in that the respective person-holding carrying element (32) is in the form of a sling hanger.

4. Device according to claim 1, characterised in that the respective person-holding carrying element (32) is in the form of a container which may be entered.

5. Device according to claim 1, characterised in that the respective person-holding carrying element (32) is in the form of a bag or tubular section at least partially encasing the person.

6. Device according to claim 1, characterised in that the at least one rope (20) or belt runs endlessly around rollers (25, 26), one being assigned to the respective storey and the other being brought at least approximately to ground level (28) under its own weight, the rope (20) or belt being driven by a motor with braking effect or by the peoples' own weight, under the effect of braking means.

7. Device according to claim 6, characterised in that in the case of the rope (20) or belt driven by the people's own weight, the braking means are assigned to at least one of the rollers (25, 26).

8. Device according to claim 6, characterised in that the support members (31) attached to the rope (20) or belt are designed as so-called Talurit clamps.

9. Device according to claim 6, characterised in that the rope (20) or belt, the rollers (25, 26) and the carrying elements (32), when the device is not in use, are arranged in an enclosure (3), in a container (4) which can be extended outwards from the building (2) or in a platform, each located in an upper storey, whereby the roller (26) which can be brought to ground level (28) is let out by the rope (20) or belt through an opening (6) in the extended container (4) or the platform respectively.

10. Device according to claim 9, characterised in that the lower roller (26) can be held in the ground area by its own weight and in any case by an additional weight (27) or can be fastened at ground level (28).

11. Device according to claim 6, characterised in that a mechanism (33) is provided to automatically detach the carrying elements (32) from the support members (31) attached to the rope (20) or belt and is preferably assigned to the axis of the lower roller (26).

12. Device according to claim 11, characterised in that an essentially curved exit part (30) for the people provided with the carrying element (32) or held in the carrying element (32) can be placed beneath the mechanism (33) for automatic detachment of the carrying elements (32) from the support members (31) attached to the rope (20) or belt.

13. Device according to claim 1, characterised in that at least two ropes (20) or belts are provided, running parallel to each other, and equipped with support members (31), where the respective carrying element (32) holding a person can be connected with one support member (31) from each of the two ropes (20) or belts.

14. Device according to claim 1, characterised in that several people are held on one carrying element (32) or similar.

15. Device according to claim 1, characterised in that in a respective building several devices (1, 70) are present, distributed over various floors.

16. Device according to claim 1, characterised in that platforms are provided in various storeys of a building on which people can connect to the rope running past these.

17. Device according to claim 1, characterised in that for evacuating persons from a building, with a hose (7) folded in a non-usage position, and unfolded in a usage position, forming an escape channel (29) extending substantially vertically from an upper floor of the building (2) to the floor (28) in the usage position, whereby the rope (20) extends through the escape channel (29).

18. Device according to claim 17, characterised in that an endless rope (20) routed around cylinders (25, 26) extends through the escape channel (29) of these cylinders (25, 26) one each is associated with the relevant floor and the other can be brought at least near to the floor (28) when the hose (7) is unfolded.

19. Device according to claim 17, characterised in that only the part (20a) of the rope (20) that is moved in a downward direction is guided through the escape channel (29), whilst the part (20b) of the same that is moved in an upward direction extends along the outside of the hose (7) and can therefore serve for stabilising the hose.

20. Device according to claim 17, characterised in that the hose (7) is equipped with a number of transverse rings (10) distributed at distances from each other across the length of the same and can be folded, e.g. unfolded in the way of a concertina, whereby the transverse rings (10) are each equipped with a guide element (22) on the inside, through which guide elements (22) of the part (20a) of the rope (20) that is moved downwards as well as a part of the carrying elements (32) connected with the carrying means (31) can be routed.

21. Device according to claim 17, characterised in that the lower cylinder (26) can be fitted to the floor (28), whereby the position of the hose (7) in relation to the building wall can be determined by means of the rope (20).

22. Device according to claim 17, characterised in that protective cushions are located inside the hose (7), which will be automatically inflated with a medium when the hose is unfolded, whereby several groups of at least two protective cushions (40) each arranged at a distance from each other are positioned across the length of the rescue channel (29), and the protective cushions (40) of the relevant group together enclose a through opening (41) for the person to be rescued at least in part in the inflated condition, whereby interim spaces (42) are provided between the protective cushions (40) and the hose (7), and the part (20a) of the rope (20) that is moved in a downward direction extends through one of the interim spaces (42).

23. Device according to claim 22, characterised in that the protective cushions (40) comprise a longitudinal cross-section extending in the transport direction in the inflated condition and cover the part (20a) of the rope (20) that is moved in a downward direction practically across the entire length of the escape channel (29).

24. Device according to claim 17, characterised in that the hose (7) folded in the non-usage position is located in a room (3) on an upper floor in a container (4) that can be extended from the building (2), whereby the hose (7) can be unfolded through a floor opening (6) of the same in the direction of the floor (28) when the container (4) is extended, and an entry opening (12) of the hose (7) can therefore be brought into a position that is coaxial to the floor opening (6).

25. Device according to claim 24, characterised in that the rope (20) equipped with the carrying means (31) can be connected to form an endless rope after the hose (7) has been unfolded, whereby one end of the rope (20) held at the entry opening (12) can be connected with the other rope end that is unwound from the coil (24) when the rope (7) is unfolded.
